(19) United States
(12) Patent Application Publication
(10) Pub. No.: US 2025/0056296 A1
(43) Pub. Date: Feb. 13, 2025

(54) METHOD ON WIRELESS COMMUNICATION FOR AERIAL USER EQUIPMENT

(71) Applicant: ZTE Corporation, Shenzhen (CN)

(72) Inventors: Jianxun AI, Shenzhen (CN); Nan ZHANG, Shenzhen (CN); He HUANG, Shenzhen (CN); Jing LIU, Shenzhen (CN); Mengjie ZHANG, Shenzhen (CN)

(73) Assignee: ZTE Corporation, Shenzhen, GD (CN)

(21) Appl. No.: 18/932,858

(22) Filed: Oct. 31, 2024

Related U.S. Application Data
(63) Continuation of application No. PCT/CN2022/109481, filed on Aug. 1, 2022.

(51) Int. Cl. H04W 24/10; H04B 17/318; H04W 56/00; H04W 76/20

(52) U.S. Cl. CPC H04W 24/10; H04B 17/328; H04W 56/0015; H04W 76/20

(57) ABSTRACT

The present disclosure describes methods, systems, and devices for selecting a resource in wireless communication. A specific configuration and an associated applicable condition is transmitted from a user equipment to a base station. The specific configuration indicates includes a synchronization signal block (SSB) subset of a plurality of SSBs and/or an SSB reference signal received power (RSRP) threshold. An SSB is selected based on the specific configuration if the associated applicable condition is met. A RACH resource is selected based on the selected SSB. A RACH preamble is transmitted on the selected RACH resource.

### CROSS-REFERENCE TO RELATED APPLICATION(S)

The present application is a continuation of International Patent Application No. PCT/CN2022/109481, filed Aug. 1, 2022. The contents of International Patent Application No. PCT/CN2022/109481 are herein incorporated by reference in their entirety.

### TECHNICAL FIELD

The present subject matter is directed generally to wireless communications. Particularly, the present subject matter relates to methods, devices, and systems for selecting a resource in wireless communication.

### BACKGROUND

In recent years, the global interest for unmanned aerial vehicle (UAV) based services has dramatically increased. Multiple drone operations, personal flight entertainment experiences, cargo delivery, and the like are a few example use cases. These and other uses may depend on enhanced remote-control capability and data transmission, which are of interest for service providers/operators as well as drone manufacturers. The original New Radio (NR) design did not anticipate uses with UAVs and accordingly, suffers from a variety of drawbacks, limitations, and disadvantages. Accordingly, there is a need for inventive methods, devices, and systems described herein.

### SUMMARY

The present subject matter is directed to a method, device, and system for improving wireless communication procedures and signaling for aerial user equipment (UE), as well as the interaction and coordination procedures between base stations.

In some embodiments, a method for wireless communication performed by a user equipment (UE) includes receiving a specific configuration and an associated applicable condition from a base station. The specific configuration comprises a synchronization signal block (SSB) subset of a plurality of SSBs; and/or an SSB reference signal received power (RSRP) threshold. The method further includes selecting an SSB based on the SSB configuration if the associated applicable condition is met. The method further includes selecting a RACH resource based on the selected SSB. The method further includes transmitting a RACH preamble on the selected RACH resource.

In some embodiments, a method for wireless communication performed by a base station includes transmitting a specific configuration and an associated applicable condition to an aerial UE. The specific comprises an SSB set of a plurality of SSBS; and/or an SSB RSRP threshold.

In some embodiments, a method for wireless communication performed by a user equipment (UE) includes receiving a measurement configuration and an associated applicable condition; and applying the measurement configuration when the associated applicable condition is met.

In some embodiments, a method for wireless communication performed by a base station includes configuring a specific RACH resource and an associated applicable condition, wherein the RACH resource is a RACH occasion or RACH preamble; and the specific RACH resource is configured in one or more of: a first initial uplink BWP of a serving cell; a second initial uplink BWP configured for a UE; or a dedicated uplink BWP.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless base stations and one or more user equipment.

FIG. 2 shows an example of a base station.

FIG. 3 shows an example of a user equipment.

FIG. 4 shows an example communication system including a base station, user equipment, and aerial user equipment.

FIG. 5 shows an example communication between a base station and user equipment.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

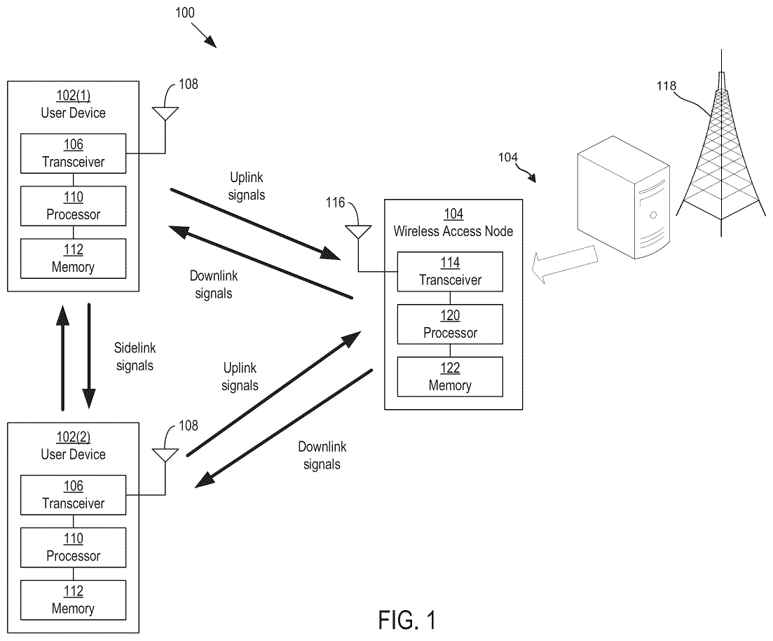

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

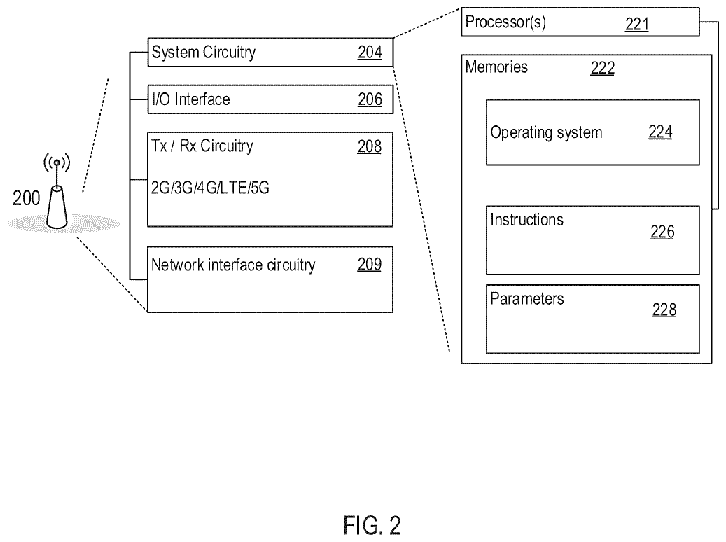

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

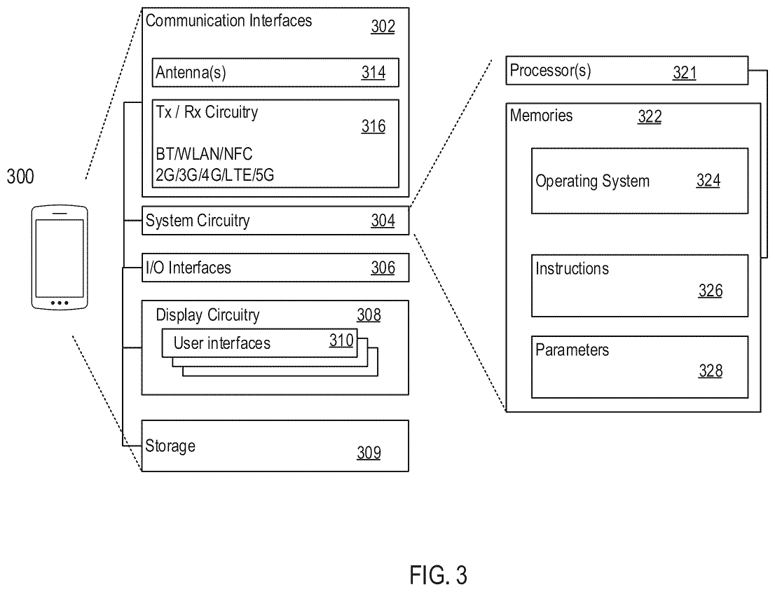

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers, and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present subject matter describes several example embodiments, which may be implemented, partly or totally, on the base station 200 and/or the aerial UE 400 and UE 300 described with reference to FIGS. 1-4.

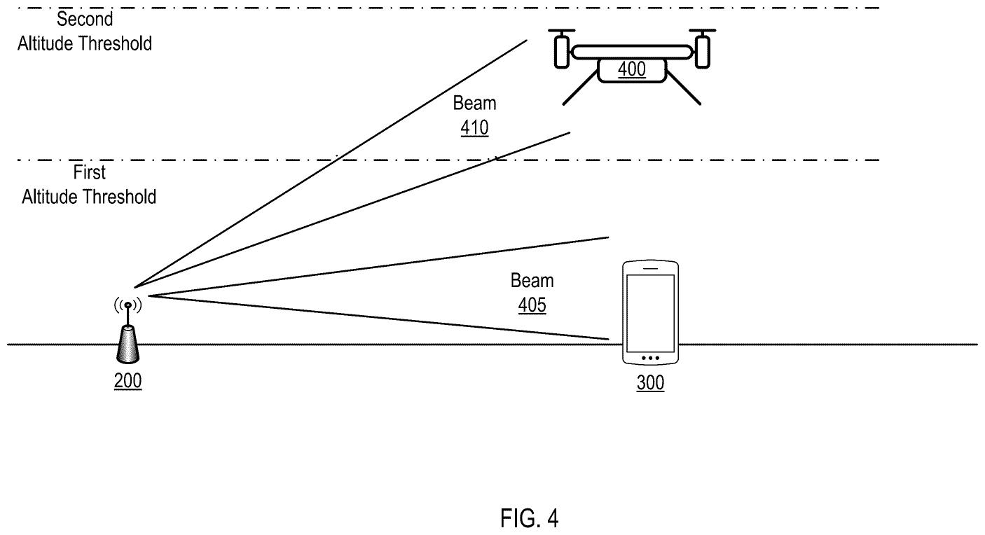

Referring to FIG. 4, the present subject matter relates to communication procedures and signaling when used with aerial UEs 400 and/or aerial UEs 400. For instance, Random Access Channel (RACH) procedures, Radio Resource Management (RRM) measurement when in Radio Resource Control (RRC) CONNECTED, RRC IDLE, and RRC INACTIVE modes, mobility, and cell selection/re-selection will be further described.

The present subject matter discloses two altitude reporting events, denoted H1and H2, for use with LTE. As used herein, altitude refers to an altitude of an aerial UE 400 or UE 300. With these two new events, the aerial UE 400 may trigger an altitude report when the aerial UE 400 reaches an altitude above (i.e., event H1) or below (i.e., event H2) one or more predetermined base station-configured threshold(s). The aerial UE 400 may determine whether its current altitude is above or below the predetermined threshold by comparing a value read from an altimeter sensor, for example, with the one or more predetermined threshold(s). Also, in accordance with the present subject matter, the RRM measurement network may be extended such that the aerial UE 400 may be configured trigger a signal strength measurement report, such as A3, A4, and/or A5, if an event condition is met for a configurable number of cells. These enhancements to LTE may help the base station (eNB) 200 to determine whether an aerial UE 400 is airborne and/or may allow the base station 200 to detect whether the aerial UE 400 is causing and/or experiencing interference.

The present subject matter discloses RRC signaling to improve mobility performance by allowing the UE to indicate its planned flight path to the base station 200. The aerial UE 400 may indicate where the aerial UE 400 is planned to travel in the future, which may be considered by the base station 200 for mobility purposes; e.g., the base station 200 may be able to use the aerial UE 400 travel information to anticipate which may be suitable for the aerial UE 400 to be transferred to and whether a new X2 connection may be advantageous to establish.

The present subject matter discloses signaling from the Core Network (CN) to the base station 200 to allow the base station 200 to determine whether a user of the aerial UE 400 has a suitable subscription. The signaling may include information about whether the aerial UE's subscription supports an aerial UE function. The base station 200 may use this information in any way suitable, depending on implementation.

### RACH Resource Selection

In the conventional NR system, RACH resources may be associated with synchronization signal (SS)/physical broadcast channel (PBCH) block, also known as the synchronization signal block (SSB) transmissions in the cell. Different SSBs may be transmitted within different beams, which may be transmitted in different directions. The aerial UE 400 may perform RACH resource selection based on measuring the signal strength of each detected SSB. That is, the aerial UE 400 may select the RACH resource associated with the SSB with a reference signal received power (RSRP) value that meets or exceeds a predetermined threshold, if available. The base station 200 may then identify which downlink beam may be used to transmit the following Msg2, Msg4, or MsgA based on the RACH resource selected by the aerial UE 400.

### RRM Measurement

In the conventional NR system, RRM measurement may be performed in the RRC CONNECTED mode for the serving cell and neighboring cell measurement, in the RRC IDLE and RRC INACTIVE modes for idle measurement, and in RRC IDLE and RRC INACTIVE mode for cell selection and reselection. The RRM measurement may be performed on the reference signaling (e.g., SSB or Channel State Information Reference Signal (CSI-RS)). The base station 200 may configure the RRM measurement via System Information (SI) or a dedicated RRC message. SI is downlink broadcast information, which is periodically transmitted by the base station 200 to the UE(s). Using SI, the UE can determine how to access the network. The typical RRM measurement configuration may include the frequency, SSB to measure, number of reference signals used to derive radio quality of the cell, and SSB measurement timing configuration (SMTC). The aerial UE 400 may measure the SSB within the configured SMTC.

When an aerial UE 400 is flying, it may initiate the RACH procedure for a variety of reasons, such as handover, RRC reestablishment, beam failure recovery, small data transmission, SCell addition, and SCG addition. In the conventional NR specification, the base station 200 configures a mapping between the SSB index transmitted in the cell and the RACH resources. The RACH resource includes a RACH slot (occasion) and a preamble. A UE 300 selects RACH resources based on the signal strength measurement results on the SSB transmitted in the cell. When signal strength measurement results (i.e., the RSRP) of an SSB exceeds a predetermined threshold, the UE selects the SSB and corresponding RACH resource for initiating the RACH procedure and transmits the RACH preamble on the corresponding RACH resource. The base station 200 subsequently identifies the downlink beam selected by the UE 300 according to the RACH resource selected by the UE 300. The base station 200 may further schedule any of the following downlink messages, including Msg2, Msg4, or MsgA during the RACH procedure with the UE-selected downlink beam. In accordance with the present subject matter, to provide service to an aerial UE 400, some beams 410 may be transmitted with a different angle to provide better signal quality to a flying aerial UE 400, depending on its altitude. For instance, to serve a UE 300 on the ground or at low altitude, the beam 405 may be transmitted with direction to the ground. While the altitude of an aerial UE 400 may be up to 8800 meters, to serve an aerial UE 400, the beam 410 may be transmitted with bigger angle comparing to the beam 405 for UE 300 on the ground. The beams 410 transmitted with a different angle may be different from the beams 405 intended for terrestrial UEs 300. As used herein, the term “terrestrial” refers to a UE 300 or aerial UE 400 located on the ground, attached to the ground, or at low altitude below a first altitude threshold.

In accordance with the present subject matter, by indicating to the aerial UE 400 the beams that are intended for the aerial UE 400 to receive, the aerial UE 400 may perform signal strength measurements with higher efficiency. For instance, the aerial UE 400 may avoid performing signal strength measurements on the beam(s) not intended for the aerial UE 400, and/or the aerial UE 400 may select the intended beam(s) with higher priority or with a lower RSRP threshold than beam(s) not intended for the aerial UE 400. Alternatively, or in addition, the aerial UE 400 may refrain from determining RSRP measurements on SSBs that are not configured using the UAV-specific SSB configuration. The base station 200 may also schedule the Msg2, Msg4, or MsgA during the RACH procedure with the intended, better-angled beams for the aerial UE 400.

### UAV-specific SSB Configuration

The aerial UE 400 may utilize a UAV-specific SSB configuration. The UAV-specific SSB configuration may be used for the aerial UE 400 to select an SSB transmitted in the cell during the RACH procedure. The UAV-specific SSB configuration may be implemented using a variety of techniques. In one technique, an SSB subset bitmap may be used where each bit of the bitmap may represent an SSB transmitted in the cell. The value of the bit may indicate whether the corresponding SSB is included in the UAV-specific SSB configuration. Alternatively, or in addition, in a second technique, a list of SSB indexes may be provided. Each value in the list may indicate that a corresponding SSB is included in the configuration. Alternatively, or in addition, in a third technique, SSB positions in a burst configuration to configure a set of SSBs to be included in the UAV-specific SSB configuration.

The SSB RSRP threshold may also be included in the UAV-specific SSB configuration and may be used in selecting an SSB for RACH resource selection, as previously described. The SSB RSRP threshold may be a separate configuration other than the SSB RSRP threshold defined in the conventional NR specification for other uses. The value of the SSB RSRP threshold may have a different value than the value of the SSB RSRP threshold defined in the conventional NR specification. The SSB RSRP threshold may be a value of the signal strength measurement result on the SSB, such as the RSRP power in dBm, for example.

### Applicable Conditions to Apply the UAV-specific SSB Configuration

The UAV-specific SSB configuration may be applied by the UE 400 and/or applicable in the context of the following conditions: (1) The altitude of the aerial UE 400 is above a predetermined altitude threshold; (2) the altitude of the aerial UE 400 exceeds a first predetermined altitude threshold and remains below a second predetermined altitude threshold; (3) the distance to the base station 200 (e.g., eNB) 200 is larger than a predetermined distance threshold; (4) the distance to the base station 200 is larger than a first predetermined distance threshold and smaller than a second predetermined distance threshold; and/or (5) a device is of type aerial UE 400.

Configuration of the UAV-specific SSB Configuration and/or Applicable Conditions

The UAV-specific SSB configuration and/or associated application condition(s) may be configured in a variety of ways. In one example, SI transmitted by the base station 200 may include the UAV-specific SSB configuration, e.g., in the Information Element (IE) RACH-ConfigCommon or RACH-ConfigCommonTwoStepRA in System Information Block 1 (SIBI), which may be used for RACH initiation, RRC setup, RRC resume, and RRC re-establishment. In another example, the UAV-specific SSB configuration may be configured in the RRC message for the aerial UE 400 in the RRC_CONNECTED mode in the RRC reconfiguration message, and/or the RRC resume message, and/or may be used for handover, beam failure recovery, SCell addition, PSCell change, and/or SCG addition.

Method of Selecting RACH Resource based on the UAV-specific SSB Configuration

The aerial UE 400 may only consider the SSB configured using the UAV-specific configuration for RACH resource selection.

In a first example method, the aerial UE 400 may only select the SSB from the SSB configured using the UAV-specific SSB configuration.

In the first example method, if at least one SSB configured in the UAV-specific SSB configuration with RSRP exceeding a predetermined threshold is available, the aerial UE 400 may select an SSB configured in the UAV-specific SSB configuration with RSRP above the predetermined threshold. Otherwise, if no SSB exists that meets the aforementioned criteria, the aerial UE 400 may select any SSB configured in the UAV-specific configuration.

Using this example method, the predetermined threshold may be the threshold defined in the conventional NR specification and applicable for other UEs/non-aerial UEs, or the predetermined threshold may be the threshold configured using the UAV-specific SSB configuration. The SSB configured using the UAV-specific SSB configuration may be the SSB transmitted for the aerial UE 400.

In a second example method, the aerial UE 400 may consider the SSB configured using the UAV-specific SSB configuration to be of higher priority.

In the second example method, if at least one SSB configured using the UAV-specific SSB configuration with RSRP exceeding a predetermined threshold is available, the aerial UE 400 may select that SSB. If no SSB exists that meets the aforementioned criteria, but at least one SSB that is not configured using the UAV-specific SSB configuration and that SSB has an RSRP that exceeds a predetermined threshold, the aerial UE 400 may select that SSB. If no SSB exists that meets either of the aforementioned criteria, the aerial UE 400 may select any SSB.

In this second example method, the predetermined threshold may be defined by the conventional NR specification and applicable for other non-aerial UEs 300, or the predetermined threshold configured using the UAV-specific SSB configuration. Using the second example method, the SSB configured using the UAV-specific SSB configuration may be the SSB transmitted for the aerial UE 400.

In a third example method, the aerial UE 400 may consider the SSB configured using UAV-specific SSB configuration having a different predetermined threshold. Specifically, an SSB configured using the UAV-specific SSB configuration and an SSB not configured using the UAV-specific SSB configuration may be selected based on different RSRP thresholds.

In the third example method, if at least one first SSB configured using the UAV-specific SSB configuration with RSRP exceeding an “A” threshold is available, or, if at least one second SSB that is not configured using the UAV-specific SSB configuration with RSRP exceeding a “B” threshold is available, select either the first or second SSB. Otherwise, if no SSB exists that meets either of the aforementioned criteria, the aerial UE 400 may select any SSB.

The “A” threshold and “B” threshold may have different values. Either “A” threshold or “B” threshold, or both the “A” threshold and “B” threshold may be configured using the UAV-specific SSB configuration. In case either “A” or “B” threshold is not configured using the UAV-specific SSB configuration, it may be configured with method and IE in conventional specification.

In a fourth example method, the aerial UE 400 may perform SSB selection with the predetermined threshold configured in the UAV-specific SSB configuration. Specifically, only the UAV-specific SSB RSRP threshold may be configured in the UAV-specific SSB configuration. When the associated application condition is satisfied, the aerial UE 400 may perform SSB selection based on the UAV-specific SSB RSRP threshold. The aerial UE 400 may not perform SSB selection based on any SSB RSRP threshold(s) configured for other cases.

In a fifth example method, the aerial UE 400 may exclude the SSB configured using the UAV-specific SSB configuration for RACH resource selection. The SSB configured using the UAV-specific SSB configuration may be transmitted to terrestrial UEs 300.

In a sixth example method, the aerial UE 400 may consider the SSB configured using the UAV-specific SSB configuration to be of lower priority.

In the sixth example method, if at least one SSB that is not configured using the UAV-specific SSB configuration with RSRP exceeding a predetermined threshold is available, the aerial UE 400 may select that SSB. If no SSB exists that meets the aforementioned criteria, but at least one SSB that is configured using the UAV-specific SSB configuration with RSRP exceeding a predetermined threshold is available, the aerial UE 400 may select that SSB. If no SSB exists that meets either of the aforementioned criteria, the aerial UE 400 may select any SSB.

In this sixth example method, the SSB that is configured using the UAV-specific SSB configuration may be the SSB transmitted for a terrestrial UE 300.

In all examples of this method, the UAV-specific SSB configuration may be exchanged between CU and DU of a base station 200.

With methods of UAV-specific SSB configuration, the reference signal (RS), which is transmitted to the aerial UE 400 flying above a certain altitude is indicated to the aerial UE 400. When the aerial UE 400 initiates RACH procedure, the aerial UE 400 may select a RACH resource by considering these RS with higher priority, or only considering these RSs. Alternatively, the RS that is transmitted to the terrestrial UE 300 is indicated to the aerial UE 400. When the aerial UE 400 initiates RACH procedure, the aerial UE 400 may consider these RS with lower priority, or not consider these RSs. Using these methods, the aerial UE 400 may have a higher probability to select an RS that is a better or best choice for the aerial UE 400.

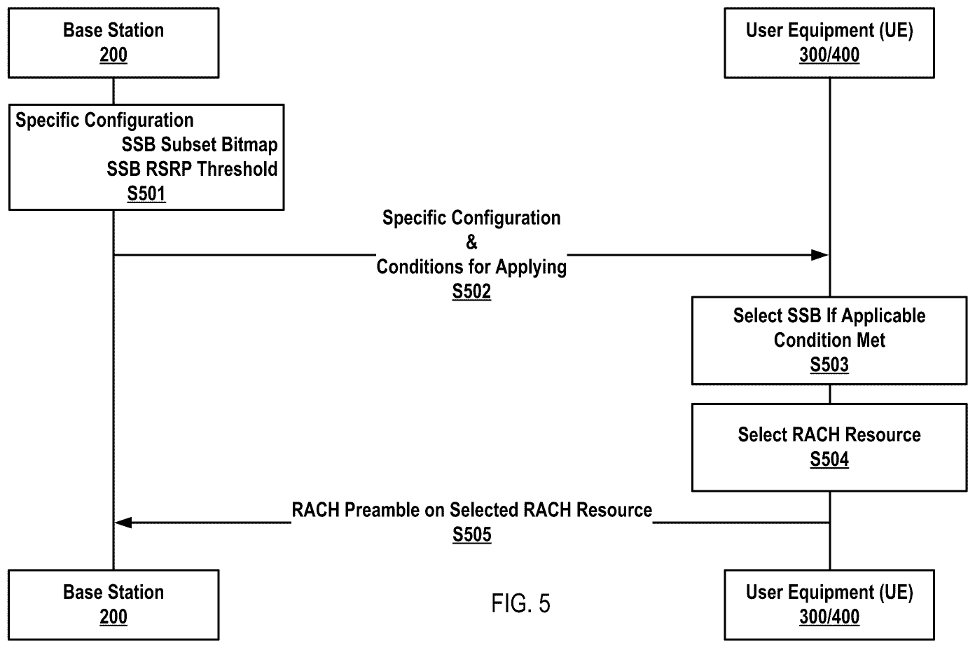

Thus, with reference to FIG. 5, the base station 200 may configure one or more UAV-specific SSB configuration(s) in S501, where each configuration is associated with the one or more applicable conditions. The UAV-specific configuration may be transmitted to the UE 300/400 in S502 in SI or using other techniques, as previously described. In S503, the UE 300/400 may select an SSB configured in the UAV-specific configuration when the applicable condition(s) is/are met. In S504, the UE 300/400 may select a RACH resource based on the selected SSB configured in the UAV-specific configuration. The UE 300/400 may then transmit a RACH preamble on the selected RACH resource in S505.

### UAV-Specific RACH Resource

The base station 200 may configure a UAV-specific RACH resource. The UAV-specific RACH resource may be a RACH slot (occasion) or a preamble of a RACH slot. The UAV-specific RACH resource may be configured in the initial uplink bandwidth part (BWP) of the serving cell, or in a separate initial uplink BWP configured for the UAV, or in a dedicated uplink BWP.

Along with the UAV-specific RACH resource, the base station 200 may configure the applicable conditions, including one or more of: (1) whether the altitude of the aerial UE 400 exceeds a predetermined threshold; (2) whether the altitude of the aerial UE 400 exceeds a first predetermined threshold while being less than a second predetermined threshold; (3) whether the distance to the base station 200 exceeds a predetermined threshold; (4) whether the distance to the base station 200 exceeds a first predetermined threshold while being less than a second predetermined threshold; and/or (5) whether the device is of a specific device type; e.g., an aerial UE device type. The base station 200 may configure the aforementioned predetermined thresholds. The aerial UE 400 may apply the UAV-specific RACH resource when the applicable condition(s) are satisfied.

The base station 200 may configure the UAV-specific RACH resources by indicating an IE featureCombinationPreambles in IE RACH-ConfigCommon. The featureCombinationPreambles may include an IE FeatureCombination, which may indicate a new feature. The new feature may be one or more of the following features: aerial UE 400 or a UE 300 above an altitude threshold.

The separate initial uplink BWP may contain a cell defining SSB (CD-SSB), or contain non-cell defining SSB (NCD-SSB). If the separate initial uplink BWP contains NCD-SSB, the aerial UE 400 may perform RACH resource selection based on the measurement on the NCD-SSB. Using this technique, these NCD-SSBs may be transmitted to serve the aerial UE 400 above a predetermined altitude. The aerial UE 400 may select the UAV-specific RACH resources based on the configured applicable conditions and perform RACH by applying the configured UAV-specific RACH resources.

The UAV-specific RACH configuration may be exchanged between CU and DU of a base station 200.

Using this method, the aerial UE 400 may apply the dedicated RACH resource when configured applicable conditions are satisfied. Thus, the base station 200 may identify whether the aerial UE 400 is flying above a predetermined altitude or is within a range of the altitude. The base station 200 may subsequently schedule the aerial UE 400 with a proper beam. For instance, the base station 200 schedules Msg2, Msg4, or MsgB during the RACH procedure with downlink beam with downlink beam, which may be transmitted at the predetermined altitude.

### UAV-Specific Measurement Configuration

The base station 200 may configure measurement configuration for an aerial UE 400. The measurement configuration may be applied under applicable conditions, which are associated with the measurement configuration. The measurement configuration may be implemented by one or more of: (1) a measurement object IE that specifies information applicable for SSB intra/inter-frequency measurements and/or CSI-RS intra/inter-frequency measurements; e.g., MeasObjectNR IE; (2) a bitmap to indicate one or more SSBs on which to perform measurement; e.g., ssb-ToMeasure IE; (3) an SSB measurement timing configuration (SMTC); (4) a threshold for consolidation of L1 measurements per RS index; e.g., an absThreshSS-BlocksConsolidation IE; and/or (5) a Number of SS blocks to average for cell measurement derivation; e.g., a nrofSS-BlocksToAverage IE. The measurement configuration may be a separate configuration in addition to the corresponding configuration in the conventional NR specification.

The applicable condition(s) may include one or more of: (1) whether the altitude of the aerial UE 400 exceeds a predetermined threshold; (2) whether the altitude of the aerial UE 400 exceeds a first predetermined threshold and is less than a second predetermined threshold; (3) whether the distance to the base station 200 exceeds a predetermined threshold; (4) whether the distance to the base station 200 exceeds a first predetermined threshold and is less than a second predetermined threshold; (5) whether the device is of a specific device type; e.g., an aerial UE device type; and/or (6) whether the aerial UE 400 is indicated to apply the measurement configuration; the indication to apply the measurement configuration may be an RRC message, an IE in an RRC message, an IE in a SIB or a MAC CE, or a DCI. The base station 200 may configure the predetermined thresholds.

The measurement configuration may be applied in any of the following scenarios. In a first scenario, the measurement configuration may be applied for the aerial UE 400 in RRC CONNECTED mode, to perform RRM measurement on a serving cell and/or neighbor cell. In a second scenario, the measurement configuration may be applied for an aerial UE 400 in the RRC IDLE and RRC INACTIVE modes to perform idle measurement. The configuration of idle measurement may be configured by SI or an RRC release message, which releases the aerial UE 400 from the RRC CONNECTED mode to the RRC IDLE or RRC INACTIVE modes. The aerial UE 400 may save idle measurement results in the RRC IDLE and RRC INACTIVE modes and report the measurement results after it is transitioned to the RRC CONNECTED mode. In a third scenario, the measurement configuration may be applied for an aerial UE 400 in RRC IDLE and RRC INACTIVE modes to perform measurements for cell selection or cell reselection. In this case, the measurement configuration may be included in SI.

For an aerial UE 400 in RRC CONNECTED mode, or for an aerial UE 400 in RRC IDLE and RRC INACTIVE modes to perform IDLE measurement, the measurement report may be performed as follows: (1) the measurement results may be reported in a separate measurement result IE; e.g,. IE MeasResults; and (2) The measurement results according to the separate measurement result IE may be reported along with measurement results according to conventional measurement configuration.

As an example, a new IE may be added to configure the measurement configuration in the MeasObjectNR in an RRC message, or the MeasIdleConfigSIB in SI, or MeasIdleConfigDedicated in an RRC message, or InterFreqCarrierFreqInfo in SI, or cellReselectionInfoCommon in SI. The newly added IE may include one or more of: (1) a new SSB-ToMeasure; (2) a new absThreshSS-BlocksConsolidation or absThreshCSI-RS-Consolidation; (3) a new nrofSS-BlocksToAverage; (4) a new SMTC; or a new IE to indicate the applicable condition; e.g., an altitude threshold.

A UAV-specific reference signal information may be exchanged between base stations 200, or between CU and DU. The exchanged information may include one or more of: (1) the information of UAV-specific SSB or CSI-RS; (2) the SMTC associated with the UAV-specific SSB or CSI-RS; or (3) the applicable conditions. The information may be exchanged between the base stations 200 in order to support neighbor cell measurement in one or more of the following scenarios: (1) between the neighbor Radio Access Network (RAN) (i.e., the gNB) upon interface setup or modification procedure. The information may be exchange on a per cell basis. The information may be exchanged in the Xn setup procedure and/or NG-RAN mode configuration update procedure. The information may be exchanged between CU and DU in one or more of following scenarios: (1) between the Centralized Unit (CU) and Distributed Unit (DU) of a base station 200; specifically, the information may be exchanged in the F1 setup procedure and/or GNB-DU configuration update procedure.

The UAV-specific measurement configuration may allow the base station 200 to configure a separate measurement configuration and associated applicable condition(s) for the aerial UE 400. The separate measurement configuration may be applied when the associated applicable condition(s) is satisfied. The aerial UE 400 may either apply the UAV-specific measurement configuration automatically; e.g., for the case of idle measurement and RRM measurement in the RRC IDLE and RRC INACTIVE modes. Alternatively, the aerial UE 400 may apply the UAV-specific measurement configuration based on an indication from the base station 200.

Thus, the base station 200 may configure different measurement configurations for the aerial UE 400 when flying above a predetermined altitude threshold or when flying in an altitude range. The base station 200 may configure a separate set of reference signals to perform measurement; e.g., the SSB or CSI-RS that was transmitted to the aerial UE 400 while airborne. Then, the aerial UE 400 may save power by avoiding performing the measurement on the SSB or CSI-RS intended for terrestrial UEs 300.

The base station 200 may configure a separate quantity of SSBs or CSI-RSs to derive cell quality. The separate quantity of SSBs or CSI-RSs may be smaller than the quantity configured for the terrestrial UEs 300 or aerial UEs 400 flying above an altitude threshold. This separate quantity may better suit the SSBs or CSI-RSs that are intended for the aerial UE 400 flying above an altitude threshold. The aerial UE 400 power may be saved by not taking the SSBs or CSI-RSs intended for terrestrial UEs 300 into account.

By applying a different measurement configuration at different altitudes, the measurement results may better reflect the radio quality of the cell.

The present subject matter describes methods, apparatus, and computer-readable medium for wireless communication. The present subject matter addressed the issues with scheduling multiple transmissions with one or more cells by reducing the number of bits needed to indicate scheduled transmissions. The methods, devices, and computer-readable medium described in the present subject matter may facilitate the performance of wireless transmission between a user equipment and a base station 200, thus improving efficiency and overall performance. The methods, devices, and computer-readable medium described in the present subject matter may improves the overall efficiency of the wireless communication systems.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication performed by a user equipment (UE), comprising: receiving a specific configuration and an associated applicable condition from a base station, wherein the specific configuration comprises: an SSB subset of a plurality of SSBs; and/or an SSB RSRP threshold; selecting an SSB based on the specific configuration if the associated applicable condition is met; selecting a RACH resource based on the selected SSB; and transmitting a RACH preamble on the selected RACH resource.

A second aspect includes a method for wireless communication performed by a base station comprising: transmitting a specific configuration and an associated applicable condition to an aerial UE, wherein the specific configuration comprises: an SSB subset of a plurality of SSBs; and/or an SSB RSRP threshold.

A third aspect includes the method of aspects 1 or 2, wherein the SSB subset of the plurality of SSBs is indicated by a bitmap where each bit of the bitmap represents an SSB transmitted in a cell.

A fourth aspect includes the method of aspect 2, further comprising: receiving a RACH preamble on a selected RACH resource from the aerial UE; identifying a downlink beam selected by the aerial UE according to the RACH resource selected by the aerial UE; and scheduling a downlink message using the identified downlink beam.

A fifth aspect includes the method of any of aspects 2-4, further comprising: exchanging the specific configuration and the associated applicable condition between a centralized unit (CU) and a distributed unit (DU) of the base station; or exchanging the specific configuration and the applicable condition between the base station and another base station.

A sixth aspect includes the method of any of aspects 2-5 wherein the SSB subset indicates whether each of the plurality of SSBs is configured for Random Access Channel (RACH) resource selection when the associated applicable condition is met.

A seventh aspect includes the method of any of aspects 2-6, wherein the SSB subset indicates whether each of the plurality of SSBs is configured for Random Access Channel (RACH) resource selection when the associated applicable condition is met.

An eighth aspect includes the method of any of aspects 2-7, wherein the exchanging of the specific configuration and the associated applicable condition occurs upon interface setup or a modification procedure on a per cell basis.

An ninth aspect includes the method of any of aspects 2-8, wherein the exchanging of the specific configuration and the associated applicable condition occurs in an Xn setup procedure and/or NG-RAN mode configuration update procedure.

A tenth aspect includes the method of any of aspects 2-9, further comprising: exchanging of the specific configuration and the associated applicable condition occurs between a Centralized Unit (CU) and Distributed Unit (DU) of the base station during an F1 setup procedure and/or GNB-DU configuration update procedure.

An eleventh aspect includes the method of any of aspects 2-10, wherein the identified downlink beam is transmitted at a different angle to the aerial UE from a downlink beam configured to be transmitted to a terrestrial UE.

An twelfth aspect includes the method of aspect 1, wherein the SSB configured using the specific configuration for RACH resource selection is transmitted from a base station in a beam configured to be received by an aerial UE.

A thirteenth aspect includes the method of any of aspects 1 and 11-12, wherein the applicable condition is an altitude of the UE exceeds a predetermined threshold.

A fourteenth aspect includes the method of any of aspects 1 and 11-13, wherein the applicable condition is an altitude of the UE exceeds a first predetermined threshold and remains below a second predetermined threshold.

A fifteenth aspect includes the method of any of aspects and 1 and 11-14, wherein the applicable condition is a distance of the UE to a base station exceeds a predetermined threshold.

A sixteenth aspect includes the method of any of aspects and 1 and 11-15, wherein the applicable condition is a distance of the UE to a base station exceeds a first predetermined threshold and remains below a second predetermined threshold.

A seventeenth aspect includes the method of any of aspects and 1 and 11-16, wherein the applicable condition is the UE is an aerial UE type.

A eighteenth aspect includes the method of any of aspects and 1 and 11-17, wherein the selecting of the SSB is based on determining that a reference signal received power (RSRP) value of the selected SSB exceeds a predetermined threshold.

An nineteenth aspect includes the method of any of aspects and 1 and 11-18, wherein the selecting of the SSB is based on determining that the selected SSB has a higher priority than another SSB having an RSRP that exceeds a predetermined threshold.

A twentieth aspect includes the method of any of aspects and 1 and 11-19, wherein the selecting of the SSB is based on determining that the selected SSB is configured using the UAV-specific has a higher priority than another SSB having an RSRP that exceeds a predetermined threshold.

A twenty-first aspect includes the method of any of aspects and 1 and 11-20, wherein the selected SSB is configured using the specific configuration for RACH resource selection.

A twenty-second aspect includes the method of any of aspects and 1 and 11-21, wherein the selected SSB is not configured using the specific configuration for RACH resource selection, and the selected SSB has an RSRP that exceeds a predetermined threshold.

A twenty-third aspect includes the method of any of aspects and 1 and 11-22, wherein the selected SSB is configured using the specific configuration for RACH resource selection, and the selected SSB has an RSRP that exceeds a predetermined threshold.

A twenty-fourth aspect includes the method of any of aspects and 1 and 11-23, wherein the step of selecting an SSB from the plurality of SSBs further comprises: determining no SSB is configured using the specific configuration for RACH resource selection, determining that no SSB that is configured with the specific configuration for rACH resource selection exists having an RSRP that exceeds a predetermined threshold, and the selected SSB is any one of the SSBs transmitted in a cell.

A twenty-fifth aspect includes the method of any of aspects and 1 and 11-24, further comprising: determining a subset of one or more SSB(s) of the plurality of SSBs exists that are not configured using the specific configuration for RACH resource selection, and refraining from performing a signal strength measurement on any of the SSB(s) within the subset.

A twenty-sixth aspect includes the method of any of aspects and 1 and 11-25, further comprising: receiving a reference signal (RS) in response to the UE flying above a predetermined threshold altitude.

A twenty-seventh aspect includes the method of any of aspects and 1 and 11-26, further comprising: measuring a signal strength of the RS.

A twenty-eighth aspect includes the method of any of aspects and 1 and 11-27, wherein the selection of the RACH resource is further based on the measured signal strength of the RS.

A twenty-ninth aspect includes a method for wireless communication performed by a user equipment (UE), comprising: receiving a measurement configuration and an associated applicable condition; and applying the measurement configuration when the associated applicable condition is met.

A thirtieth aspect includes the method of aspects 29 wherein the measurement configuration is implemented by a bitmap to indicate one or more SSBs on which to perform measurement.

A thirty-first aspect includes the method of aspects 29 or 30, wherein the measurement configuration is implemented by an SSB measurement timing configuration (SMTC).

A thirty-second aspect includes the method of any of aspects 29-31, wherein the measurement configuration is implemented by a predetermined threshold for consolidation of L1 measurements per RS index.

A thirty-third aspect includes the method of any of aspects 29-32, wherein the measurement configuration is implemented by a number of SS blocks to average for cell measurement derivation.

A thirty-fourth aspect includes the method of any of aspects 29-33, wherein the measurement configuration is applied in an RRC CONNECTED mode to perform measurement on a serving and/or neighbor cell.

A thirty-fifth aspect includes the method of any of aspects 29-34, wherein the measurement configuration is applied in an RRC IDLE and an RRC INACTIVE modes to perform idle measurement.

A thirty-sixth aspect includes the method of any of aspects 29-35, wherein the idle measurement is configured by System Information received from the base station or an RRC release message that releases the UE from the RRC CONNECTED mode to the RRC IDLE or RRC INACTIVE modes.

A thirty-seventh aspect includes the method of any of aspects 29-36, wherein the measurement configuration is configured by System Information received from the base station and applied in an RRC IDLE and RRC INACTIVE modes to perform measurements for cell selection or reselection.

A thirty-eighth aspect includes the method of any of aspects 29-37, wherein the associated applicable condition comprises one or more of: whether an altitude of the UE exceeds a first predetermined threshold; whether the altitude of the UE exceeds a second predetermined threshold and is less than a third predetermined threshold; whether a distance to a base station exceeds a fourth predetermined threshold; whether the distance to the base station exceeds a fifth predetermined threshold and is less than a sixth predetermined threshold; whether the UE is a specific device type; or whether the UE is indicated to apply the measurement configuration.

A thirty-ninth aspect includes the method of any of aspects 29-38, wherein the indication to apply the measurement configuration is an RRC message, an IE in an RRC message, an IE in a SIB, an IE in a MAC CE, or a DCI.

A fortieth aspect includes the method of any of aspects 29-39, wherein a base station configures one or more of the first, second, third, fourth, fifth, or sixth predetermined thresholds.

A forty-first aspect includes a method for wireless communication performed by a base station, comprising: configuring a specific RACH resource and an associated applicable condition, wherein the RACH resource is a RACH occasion or RACH preamble; and the specific RACH resource is configured in one or more of: a first initial uplink BWP of a serving cell; a second initial uplink BWP configured for a UE; or a dedicated uplink BWP.

A forty-second aspect includes the method of aspect 41, wherein the associated applicable condition comprises one or more of: whether the altitude of the UE exceeds a first predetermined threshold; whether the altitude of the UE exceeds a second predetermined threshold while being less than a third predetermined threshold; whether a distance to the base station exceeds a fourth predetermined threshold; whether the distance to the base station exceeds a fifth predetermined threshold while being less than a sixth predetermined threshold; or whether the UE is a specific device type.

A forty-third aspect includes the method of aspects 41 or 42, further comprising: configuring one or more of the first, second, third, fourth, fifth, or sixth predetermined thresholds.

A forty-fourth aspect includes the method of any one of aspects 41-43, wherein the step of configuring the specific RACH resource further comprises: indicating an IE featureCombinationPreambles in an IE RACH-ConfigCommon.

A forty-fifth aspect includes the method of any one of aspects 41-44, wherein the IE featureCombinationPreambles is associated to one or more of the following features: an aerial UE, or a UE that exceeds an altitude threshold.

A forty-sixth aspect includes the method of any one of aspects 41-45, wherein the second initial uplink BWP configured for a UE includes a cell-defining SSB (CD-SSB) or a non-cell defining SSB (NCD-SSB).

A forty-seventh aspect includes the method of any one of aspects 41-46, further comprising: transmitting the NCD-SSB to the UE when the UE exceeds a predetermined threshold altitude.

A forty-eighth aspect includes a device for wireless communication comprising: a processor; and a memory in communication with the processor, the memory storing a plurality of instructions executable by the processor to cause the device to: implement a method of any preceding aspect.

A forty-ninth aspect includes a non-transitory computer-readable medium comprising instructions operable, when executed by one or more processors, to: implement a method of any one of aspects 1-47.

1. A method for wireless communication performed by a user equipment (UE), comprising:
receiving a measurement configuration and an associated applicable condition; and
applying the measurement configuration when the associated applicable condition is met.

2. The method of claim 1, wherein
the measurement configuration is implemented by a bitmap to indicate one or more SSBs on which to perform measurement.

3. The method of claim 1, wherein
the measurement configuration is implemented by an SSB measurement timing configuration (SMTC).

4. The method of claim 1, wherein
the measurement configuration is implemented by a predetermined threshold for consolidation of L1 measurements per RS index.

5. The method of claim 1, wherein
the measurement configuration is implemented by a number of SS blocks to average for cell measurement derivation.

6. The method of claim 1, wherein
the measurement configuration is applied in an RRC CONNECTED mode to perform measurement on a serving and/or neighbor cell.

7. The method of claim 1, wherein
the measurement configuration is configured by System Information received from a base station and applied in an RRC IDLE and RRC INACTIVE modes to perform measurements for cell selection or reselection.

8. The method of claim 1, wherein
the associated applicable condition comprises:
whether an altitude of the UE exceeds a first predetermined threshold and is less than a second predetermined threshold.

9. A device for wireless communication comprising:
one or more processors; and
a memory in communication with the one or more processors, the memory storing a plurality of instructions executable by the one or more processors to cause the device to:
receive a measurement configuration and an associated applicable condition; and
apply the measurement configuration when the associated applicable condition is met.

10. The device of claim 9, wherein
the measurement configuration is implemented by a bitmap to indicate one or more SSBs on which to perform measurement.

11. The device of claim 9, wherein
the measurement configuration is implemented by an SSB measurement timing configuration (SMTC).

12. The device of claim 9, wherein
the measurement configuration is implemented by a predetermined threshold for consolidation of L1 measurements per RS index.

13. The device of claim 9, wherein
the measurement configuration is implemented by a number of SS blocks to average for cell measurement derivation.

14. The device of claim 9, wherein
the measurement configuration is applied in an RRC CONNECTED mode to perform measurement on a serving and/or neighbor cell.

15. The device of claim 9, wherein
the measurement configuration is configured by System Information received from a base station and applied in an RRC IDLE and RRC INACTIVE modes to perform measurements for cell selection or reselection.

16. The device of claim 9, wherein
the associated applicable condition comprises:
whether an altitude of the UE exceeds a first predetermined threshold and is less than a second predetermined threshold.

17. A non-transitory computer-readable medium storing a plurality of instructions executable by one or more processors, and when executed, the plurality of instructions is configured to cause the one or more processors to:
receive a measurement configuration and an associated applicable condition; and
apply the measurement configuration when the associated applicable condition is met.

18. The non-transitory computer-readable medium of claim 17, wherein
the measurement configuration is implemented by a bitmap to indicate one or more SSBs on which to perform measurement.

19. The non-transitory computer-readable medium of claim 17, wherein
the measurement configuration is implemented by an SSB measurement timing configuration (SMTC).

20. The non-transitory computer-readable medium of claim 17, wherein
the associated applicable condition comprises:
whether an altitude of the UE exceeds a first predetermined threshold and is less than a second predetermined threshold.
